(19) United States
(12) Patent Application Publication
(10) Pub. No.: US 2012/0251698 A1
(43) Pub. Date: Oct. 4, 2012

(54) CAMP TAILGATE COOKING SYSTEMS

(76) Inventor: Gilbert Dennis, Mansfield, TX (US)

(21) Appl. No.: 13/352,390

(22) Filed: Jan. 18, 2012

Related U.S. Application Data
(60) Provisional application No. 61/471,374, filed on Apr. 4, 2011.

(51) Int. Cl. A47J 37/07; A23L 1/221; A23L 1/01

(52) U.S. Cl. 426/523; 99/339; 99/332

(57) ABSTRACT

A portable cooking system comprises a grilling assembly including: a grill-housing with a rotatable lid and doors; a generator for generating electricity, the generator being removably couplable within confines of the grill-housing; a water container with water dispensed from the water container; a grill rack; a side burner; at least one convection fan located in the rotatable lid; a control panel useful to set temperature(s) and cooking times; a first removable sliding drawer, the first removable sliding drawer for catching and containing grease drippings; a second removable sliding drawer, the second removable sliding drawer for containing wood chips for flavoring food as it cooks; a pull-out table top useful for setting at least one cooking-related item; a spice rack shelf; an inner storage and utensil storage shelf; electrical outlets located on a back of the grill-housing; and wheels such that the grilling assembly is movable about a planar surface.

### CROSS-REFERENCE TO RELATED APPLICATION

The present application is related to and claims priority from prior provisional application Ser. No. 61/471,374, filed Apr. 4, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of cooking devices and more specifically relates to camp tailgate cooking systems.

2. Description of the Related Art

A barbecue grill is traditionally a device for cooking food by applying heat directly from below. There are several varieties of such grills such as gas-fueled and charcoal. Barbecuing is a pervasive tradition in much of the world. Gas-fueled grills typically use propane (LP) or natural gas (NG) as their fuel source, with gas-flame either cooking food directly or heating grilling elements which in turn radiate the heat necessary to cook food. Gas grills are available in sizes ranging from small, single steak grills up to large, industrial sized restaurant grills which are able to cook enough meat to feed a hundred or more people. Gas grills are designed for either LP or NG, although its possible to convert a grill from one gas source to another with relative ease. The majority of gas grills follow the cart grill design concept: the grill unit itself is attached to a wheeled frame that holds the fuel tank. The wheeled frame may also support side tables and other features.

Many individuals enjoy grilling foods at picnics, camp sites, and various types of parties and events away from their residence. Traditional grills may require the use of charcoal briquettes, propane, and other similar fuels to produce cooking heat. These heating means may be inefficient, unsafe, and may cause excessive production of smoke and ash, which may be harmful to the environment. Also, food cooked on traditional grills may cook unevenly, causing the food to be unappetizing and potentially unhealthy to eat.

Various attempts have been made to solve the above-mentioned problems such as those found in U.S. Pat. Nos. 4,800,865; 6,369,366; 5,197,379; 5,168,860; 6,651,646; and 4,317,025. This prior art is representative of cooking devices and means. None of the above inventions and patents, taken either singly or in combination, is seen to describe the invention as claimed.

Ideally, a camp tailgate cooking system should be safe in use, portable and, yet would operate reliably and be manufactured at a modest expense. Thus, a need exists for a reliable camp tailgate cooking system to avoid the above-mentioned problems.

### BRIEF SUMMARY OF THE INVENTION

In view of the foregoing disadvantages inherent in the known cooking device art, the present invention provides a novel camp tailgate cooking system. The general purpose of the present invention, which will be described subsequently in greater detail is to provide a safe, portable and efficient camp tailgate cooking system.

Camp Tailgate Cooking System provides consumers with an efficient and healthy alternative to traditional grills. This innovative product features a generator-powered grilling system that utilizes conduction, convection, and infrared heat for cooking foods. Using these types of heat may significantly reduce the amount of energy necessary to cook food, and may also help ensure that the food is evenly and healthfully cooked with minimal residual grease. This device can also be used to store all necessary cooking equipment, allowing consumers to use this product in virtually any indoor or outdoor environment.

A portable cooking system is disclosed herein, in a preferred embodiment comprising a grilling assembly. The grilling assembly includes: a grill-housing with a rotatable lid and doors; a generator for generating electricity (the generator being removably couplable within confines of the grill-housing); a water container (integrally mounted) wherein the water is able to be dispensed from the water container (for use in cooking and/or drinking); a grill rack; a side burner; at least one convection fan located in the rotatable lid; a control panel useful to set temperature(s) and cooking times and the like; a first removable sliding drawer (the first removable sliding drawer for catching and containing grease drippings); a second removable sliding drawer (the second removable sliding drawer for containing wood chips for flavoring food as it cooks); a pull-out table top useful for setting at least one cooking-related item; a spice rack shelf; an inner storage and utensil storage shelf; electrical outlets located on a back of the grill-housing; and wheels such that the grilling assembly is movable about a planar surface.

The rotatable lid provides access to the grill rack to contain heat to cook the food. The rotatable lid comprises a front-window in preferred embodiments. The front-window allows a user to view the food as it cooks on the grill rack; wherein the grill rack is removably-mounted within the grilling assembly allowing at least one food to be situated thereon for a cooking period.

The side burner preferably comprises an infrared top-burner which is electrically operated. The spice rack shelf and the inner storage and utensil storage shelf are located within the confines of a first inner volume of the grill-housing. The wheels comprise two rotatable wheels and two non-rotatable wheels located on a bottom of the grill-housing. The generator comprises an electrical plug-in such that when the generator is removed from within confines of the grill-housing, the generator is able to be plugged into an electrical source to recharge the generator for at least one future use. In certain embodiments the generator need not be removed for charging. The convection fan(s) displaces heated air about the food to promote even cooking of the food. The control panel comprises a timer and is programmable.

A method for using a camp tailgate cooking system is also disclosed herein comprising the steps of: activating a convection fan located in a rotatable lid with the convection fan powered via a generator; placing a food item on a grill rack; cooking the food item allowing grease to drop into a first removable sliding drawer; and removing the food item for eating; and flavoring the food while cooking using wood chips located in a second removable sliding drawer. The food, when cooked, is removed for consumption.

The present invention holds significant improvements and serves as a camp tailgate cooking system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, camp tailgate cooking system, constructed and operative according to the teachings of the present invention.

FIG. 1 shows a perspective view illustrating a grill of a camp tailgate cooking system in a closed condition according to an embodiment of the present invention.

FIG. 2 is a perspective view illustrating the grill of the camp tailgate cooking system in an in-use condition according to an embodiment of the present invention of FIG. 1.

FIG. 3 is a perspective view illustrating first and second removable sliding drawers in an open condition according to an embodiment of the present invention of FIGS. 1 and 2.

FIG. 4 is a perspective view illustrating a back region of the grill according to an embodiment of the present invention of FIGS. 1-3.

FIG. 5 is a flowchart illustrating a method of using the camp tailgate cooking system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a cooking device and more particularly to a camp tailgate cooking system as used to improve the safety and efficiency of portable cooking processes.

Generally speaking, camp tailgate cooking system allows consumers to safely and efficiently grill foods. The invention may comprise a grilling system that utilizes conduction, convection, and infrared heat for cooking foods. The grill portion of the unit can be covered by a rounded lid containing a window, through which users may look to watch their food cook, and a convection fan on the inside top portion of the lid. On the front of the lid may be a control panel, which consumers may use to set the temperatures and cooking times required for specific foods. Users can grasp a handle on the front of the lid to lift the lid and access the grill. Extending from the right side of the unit may be an infrared top burner. A pull-out table top may be included on the left side of the unit. The infrared top burner and pull-out table may be interchanged side-to-side on alternate embodiments.

Directly beneath the lid can be two drawers; one can contain a grease pan, while the other may contain wood chips for flavoring (optionally used). Beneath the drawers may be two doors, which users may open to access a shelved storage area. The top shelf can be used to store spices. The second shelf may have one compartment designed to house a water jug (containing means) with a dispensing nozzle, and the other compartment may house a generator. The remaining space beneath the second shelf can be used for storing other various cooking utensils and items. To power the invention, users may remove the generator from its storage space and plug it into outlets on the back of the unit. Two stationary rubber feet can be located on the bottom left side of the unit, and two wheels can be located on the bottom right side of the unit. To move the invention, users may tilt the unit onto the wheels and push while grasping a handle on the left side of the unit. This product may be used in both indoor and outdoor environments.

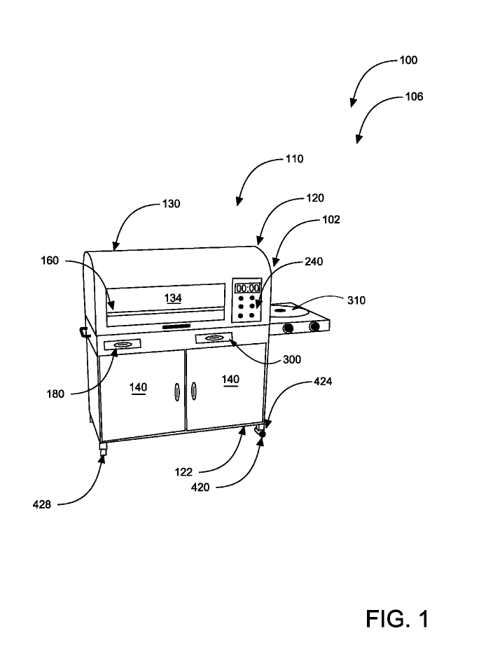

Referring to the drawings by numerals of reference there is shown in FIG. 1 shows a perspective view illustrating grill of a camp tailgate cooking system 100 in closed condition 106 according to an embodiment of the present invention.

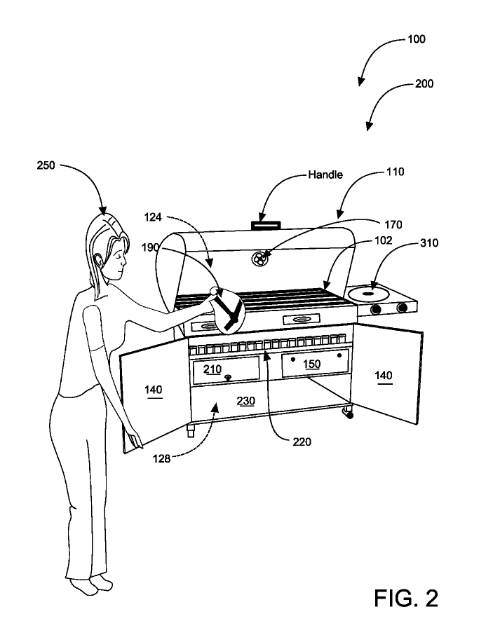

Grill of a camp tailgate cooking system (portable cooking system) 100 preferably comprises grilling assembly 110. Grilling assembly 110 preferably includes grill-housing 120 with at least one rotatable lid 130; doors 140; generator 150 for generating electricity, generator 150 being removably couplable within confines of grill-housing 120 (shown in FIG. 2); grill rack 160; at least one convection fan 170 located in rotatable lid 130 for preferably displacing heated air about food 190 to promote even cooking of food 190; and at least one first removable sliding drawer 180, first removable sliding drawer 180 for catching and containing grease drippings.

Rotatable lid 130 preferably provides access to grill rack 160. Grill rack 160 is mounted within grilling assembly 110 thereby allowing at least one food 190 to be situated thereon for a cooking period. Doors 140 and rotatable lid 130 permit access to first inner volume 124 and second inner volume 128, respectively, of grill-housing 120 of grilling assembly 110. Portable cooking system 100 utilizes conduction, convection, and infrared heat to cook food 190 placed on grill rack 160 located in grilling assembly 110.

Referring now to FIG. 2, a perspective view illustrating grill 102 of camp tailgate cooking system 100 in an in-use condition 200 according to an embodiment of the present invention of FIG. 1.

Grilling assembly 110 preferably further comprises water container 210. Water is preferably able to be dispensed from water container 210 for cooking and/or drinking. Grilling assembly 110 further comprises spice rack shelf 220 located within confines of first inner volume 124 of grill-housing 120. Spice rack shelf 220 provides an area for user 250 to store user-preferred spices that user 250 user needs during barbequing of food 190 making it convenient in-use.

Grilling assembly 110 also comprises utensil storage shelf 230 and control panel 240 in preferred embodiments. Utensil storage shelf 230 preferably provides a region for user 250 to store various utensils that user 250 uses during at least one barbequing period. Control panel 240 is preferably useful to set temperature(s) and cooking times. Control panel 240 comprises timer 244 and is preferably programmable so as to set temperatures and/or times and the like for cooking food 190. Rotatable lid 130 preferably comprises front-window 134. Front-window 134 (also shown in FIG. 1) allows user 250 to view food 190 as it cooks on grill rack 160.

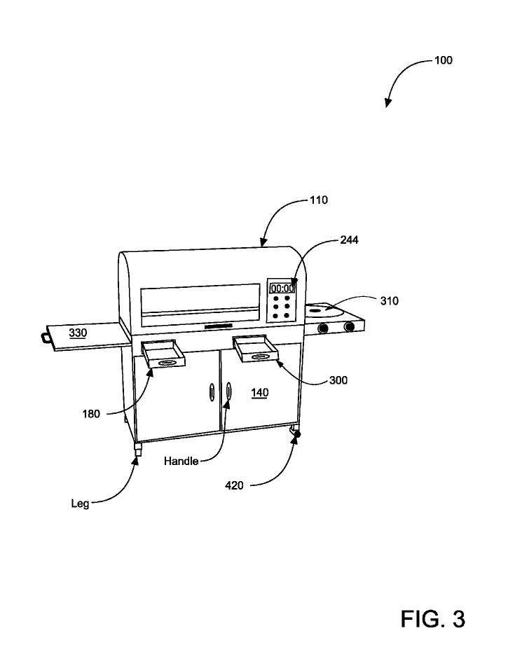

Referring now to FIG. 3, a perspective view illustrating first and second removable sliding drawers 180 and 300 (respectively) in an open condition according to an embodiment of the present invention of FIGS. 1 and 2.

Grilling assembly 110 preferably comprises at least one second removable sliding drawer 300, second removable sliding drawer 300 for containing wood chip for flavoring said food 190 as it cooks. Grilling assembly 110 may also comprise pull-out table top 330 to prepare and season food 190 prior to cooking food 190.

Grilling assembly 110 further comprises side burner 310. Side burner 310 preferably comprises an infrared top-burner which is electrically operated and is suitable for heating and cooking food 190 in a cooking pot or the like. This may be useful when soups, sauces, broths and the like are being prepared for the meal. This provides that the present invention comprises a multi-purpose cooking device.

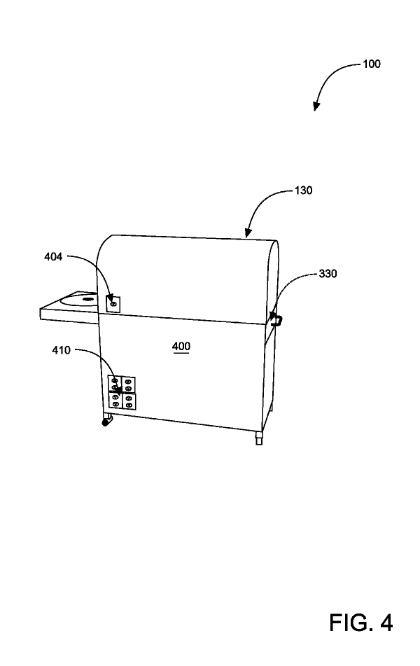

FIG. 4 is a perspective view illustrating back region 400 of grill 102 according to an embodiment of the present invention of FIGS. 1-3.

Generator 150 comprises an electrical plug-in 410 in preferred embodiments such that when generator 150 is removed from within confines of grill-housing 120, generator 150 is able to be plugged into an electrical source to recharge generator 150 for at least one future use. Generator 150 may be used to power camp tailgate cooking system 100 in remote and non-remote locations. Grilling assembly 110 further comprises electrical outlets 404 located on back region 400 of grill-housing 120.

Grilling assembly 110 further comprises wheels 420, such that grilling assembly 110 is movable about a planar surface. Wheels 420 are also shown in FIG. 1. Wheels 420 comprise two rotatable wheels 424 and two non-rotatable wheels 428 (or legs in certain embodiments) located on bottom 122 of grill-housing 120.

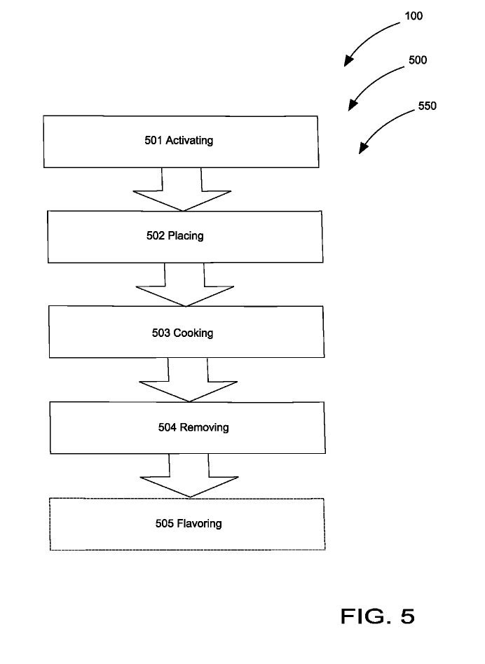

Referring now to FIG. 5 showing a flowchart 550 illustrating a method of using (enabling method of use 500) camp tailgate cooking system 100 according to an embodiment of the present invention of FIGS. 1-4.

A method of using (enabling method of use 500) camp tailgate cooking system 100 preferably comprises the steps of: step one 501 activating convection fan 170 located in rotatable lid 130 with convection fan 170 powered via generator 150; step two 502 placing an item of food 190 on grill rack 160; step three 503 cooking the item of food 190 allowing grease to drop into first removable sliding drawer 180; step four 504 removing the item of food 190 for eating; and step five 505 flavoring food 190 while cooking using wood chips located in second removable sliding drawer 300.

It should be noted that step 505 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable cooking system comprising:
a grilling assembly including;
a grill-housing with at least one rotatable lid and doors;
a generator for generating electricity, said generator being removably couplable within confines of said grill-housing;
a grill rack;
at least one convection fan located in said rotatable lid;
at least one first removable sliding drawer, said first removable sliding drawer for catching and containing grease drippings;
wherein said rotatable lid provides access to said grill rack;
wherein said grill rack is mounted within said grilling assembly allowing at least one food to be situated thereon for a cooking period;
wherein said convection fan(s) displaces heated air about said food to promote even cooking of said food;
wherein said doors and said rotatable lid permit access to a first inner volume and a second inner volume, respectively of said grill-housing of said grilling assembly; and
wherein said portable cooking system utilizes conduction, convection, and infrared heat to cook said food placed on said grill rack located in said grilling assembly.

2. The portable cooking system of claim 1 further comprising a water container, said water container integrally mounted, wherein water is able to be dispensed from said water container.

3. The portable cooking system of claim 1 further comprising at least one second removable sliding drawer, said second removable sliding drawer for containing wood chip for flavoring said food as it cooks.

4. The portable cooking system of claim 1 further comprising a side burner.

5. The portable cooking system of claim 4 wherein said side burner comprises an infrared top-burner which is electrically operated.

6. The portable cooking system of claim 1 further comprising a spice rack shelf located within confines of said first inner volume of said grill-housing.

7. The portable cooking system of claim 6 wherein said rotatable lid comprises a front-window.

8. The portable cooking system of claim 7 wherein said front-window allows a user to view said food as it cooks on said grill rack.

9. The portable cooking system of claim 8 further comprising a pull-out table top.

10. The portable cooking system of claim 9 further comprising a utensil storage shelf.

11. The portable cooking system of claim 10 further comprising wheels, such that said grilling assembly is movable about a planar surface.

12. The portable cooking system of claim 1 wherein said wheels comprise two rotatable said wheels and legs located on a bottom of said grill-housing.

13. The portable cooking system of claim 1 wherein said generator comprises an electrical plug-in such that when said generator is removed from within said confines of said grill-housing, said generator is able to be plugged into an electrical source to recharge said generator for at least one future use.

14. The portable cooking system of claim 13 further comprising electrical outlets located on a back of said grill-housing.

15. The portable cooking system of claim 14 further comprising a control panel useful to set temperature(s) and cooking times.

16. The portable cooking system of claim 15 wherein said control panel comprises a timer.

17. The portable cooking system of claim 16 wherein said control panel is programmable.

18. A portable cooking system comprising:
a grilling assembly including;
a grill-housing with a rotatable lid and doors;
a generator for generating electricity, said generator being removably couplable within confines of said grill-housing;
a water container;
a grill rack;
a side burner;
at least one convection fan located in said rotatable lid;
a control panel useful to set temperature(s) and cooking times;
a first removable sliding drawer, said first removable sliding drawer for catching and containing grease drippings;
a second removable sliding drawer, said second removable sliding drawer for containing wood chips for flavoring food as it cooks;
a pull-out table top useful for setting at least one cooking-related item;
a spice rack shelf;
an inner storage and utensil storage shelf;
electrical outlets located on a back of said grill-housing; and
wheels such that said grilling assembly is movable about a planar surface;
wherein said rotatable lid provides access to said grill rack to contains heat to cook said food;
wherein said rotatable lid comprises a front-window;
wherein said front-window allows a user to view said food as it cooks on said grill rack;
wherein water is able to be dispensed from said water container;
wherein said grill rack is removably-mounted within said grilling assembly allowing at least one food to be situated thereon for a cooking period;
wherein said side burner comprises an infrared top-burner which is electrically operated;
wherein said spice rack shelf and said inner storage and utensil storage shelf are located within confines of a first inner volume of said grill-housing;
wherein said wheels comprise two rotatable said wheels and legs located on a bottom of said grill-housing;
wherein said generator comprises an electrical plug-in such that when said generator is removed from within said confines of said grill-housing, said generator is able to be plugged into an electrical source to recharge said generator for at least one future use;
wherein said convection fan(s) displaces heated air about said food to promote even cooking of said food(s);
wherein said control panel comprises a timer;
wherein said control panel is programmable;
wherein said doors and said rotatable lid permit access to said first inner volume and a second inner volume, respectively of said grill-housing of said grilling assembly; and
wherein said portable cooking system utilizes conduction, convection, and infrared heat to cook said food(s) cooked by said grilling assembly.

19. A method for using a portable cooking system comprising the steps of:
activating a convection fan located in a rotatable lid said convection fan powered via a generator;
placing a food item on a grill rack;
cooking said food item allowing grease to drop into a first removable sliding drawer; and
removing said food item for eating.

20. The method of claim 19 further comprising the step of flavoring said food while cooking using wood chips located in a second removable sliding drawer.
